(19) United States
(12) Patent Application Publication
(10) Pub. No.: US 2010/0101661 A1
(43) Pub. Date: Apr. 29, 2010

(54) REUSABLE SHIPPING AND PACKING MATERIALS AND METHOD OF USE

(75) Inventors: Robert Hamm, San Diego, CA (US); Carlos Rico Oliva, San Diego, CA (US); Steven Fouskarinis, San Diego, CA (US)

Correspondence Address: FOLEY & LARDNER LLP, P.O. BOX 80278, SAN DIEGO, CA, 92138-0278, US

(73) Assignee: Eco Rebox LLC

(21) Appl. No.: 12/538,061

(22) Filed: Aug. 7, 2009

Related U.S. Application Data
(60) Provisional application No. 61/108,885, filed on Oct. 28, 2008.

(51) Int. Cl. F16K 15/20

(52) U.S. Cl. 137/223

(57) ABSTRACT

An air bladder valve arrangement includes a tube having a cavity therein, the cavity having a plurality of chambers, each chamber being associated with one or more air bladder chambers, a stem positioned within the tube, the stem having a plurality of plungers, each plunger being positioned within a chamber of the cavity of the tube, each plunger being configured to selectively open and close communication of air between adjacent chambers of the cavity of the tube, wherein the stem is movable relative to the tube to position each of the plurality of the plungers to selectively open and close communication of air between adjacent chambers.

### CROSS-REFERENCE TO RELATED PATENT APPLICATIONS

This application claims benefit of priority from U.S. Provisional Patent Application No. 61,108,885, filed Oct. 28, 2008, which is hereby incorporated by reference in its entirety and for all purposes. This application further incorporates by reference U.S. patent application Ser. No. 12/208,305, filed Sep. 10, 2008, in its entirety.

### BACKGROUND OF THE INVENTION

This disclosure relates to materials for shipping and methods for reusing recyclable shipping materials in the storage and transportation of goods so that the materials may be used more than once for the same function or purpose. The shipping materials are transferred to and from consumers and transferred to and from manufacturers for use or reuse. Shipping and delivery services may also provide reusable and recyclable shipping containers for the use of their customers.

The packaging industry is reportedly the largest consumer of cardboard and plastics and the second largest consumer of polystyrene in the United States. These packaging materials have significant negative impacts on the environment. For example, it has been reported that paper and paperboard products constitute a large portion of the nation's municipal solid waste stream. The production of paper and paperboard products reportedly generates over 1.5 billion gallons of wastewater annually, and over 500 gallons of water are reportedly required to process every tree. In landfill waste, over 1.5 tons of greenhouse gases are reportedly emitted for every ton of paper produced, equivalent to the amount produced if five million cars drove from Seattle to Atlanta. One report regarding paper production states that such production is the third most energy-intensive industry in the United States, consuming 11.5 percent of all of the energy in the industrial sector. Much of the world's paper supply reportedly comes from timber logged in regions with ecologically valuable and biologically diverse habitat.

Plastics and polystyrene usage also negatively affect the environment. It was reported that in 1999, over 13 million tons of plastics, approximately 40% of total plastics, were used for packaging, consuming over 600 billion gallons of water. Expanded polystyrene foam reportedly takes approximately 900 years to decompose in the environment, and polystyrene recycling is reportedly not “closed-loop,” meaning that more resources must be used and more pollution created during its production. In categories of energy consumption, it has been reported that greenhouse gas effects, and total environmental effects, and expanded polystyrene's environmental impacts are only second to aluminum.

### SUMMARY OF THE INVENTION

Packaging materials are an urgent focus for sustainability. Generally, the packaging industry is still adhering to the traditional “4-R” waste management approach (Reduce, Re-use, Recycle, Recover) rather than evaluating and assessing the life cycle impacts of traditional packaging, and rather than developing strategies to reduce the environmental impacts of using traditional packaging materials. As a result, the primary emphasis in trying to avoid environmental impacts still focuses on “down gauging” and “recyclability.” Although the 4-R approach may lead to a minor reduction of environmental impacts in the short term, it does not take into account the need to reduce overall environmental impacts of traditional packaging in a substantial way. In the future, successful packaging systems must minimize the impact on the environment while seamlessly meeting social requirements and expectations.

Embodiments of the present invention provides an innovative, environmentally conscious, reusable, self-contained shipping system which can reduce the need for traditional packaging materials such as corrugated boxes, packing boxes, wood, polystyrene, packing “peanuts,” plastic shrink-wrap, “bubble” wrap and wooden pallets. Embodiments of the present invention may transform the shipping and packaging infrastructure across various industries by moving away from one-time use, disposable materials to a recycling-based solution with a lifespan of at least ten to fifteen uses. Embodiments of the present inventions may apply to anything that is otherwise now packed into a standard or custom sized box, such as refrigerators and appliances, computers, televisions, custom cabinetry, furniture and other household and commercial goods, and can be applied in the residential and commercial moving industries. The end result is the substantial reduction of packaging materials used, a seamless transition in terms of logistics and labor, a profound reduction of negative environmental effects, and a tremendous cost savings.

Accordingly, embodiments of the present invention provide an innovative, environmentally conscious, reusable, self-contained shipping system and related methods that may replace the need for traditional packaging materials such as corrugated boxes, packing boxes, wood, polystyrene, packing “peanuts,” plastic shrink-wrap, “bubble” wrap, wooden pallets and the like. Product manufacturers and shipping and delivery services may be supplied with reusable shipping materials to meet their sustained shipping requirements. Existing manufacturer and other shipping and distribution channels may be used to transfer the manufactured products packaged in the shipping materials to the consumer or end user. The consumer may be offered an incentive or rebate to return the materials to a service center for processing and redistribution. The reusable shipping materials may then be transferred to a product manufacturer or a shipping and delivery service to complete the present cycle and to be used in a subsequent cycle.

In a first aspect, an embodiment of the present invention includes a reusable and recyclable shipping assembly. The assembly may include, without limitation, a container and one or more fastener assemblies disposed in the container. The container may be formed from a single continuous flat pattern, or it may be formed from multiple parts that are connected or attached together. The fastener assemblies may be used, without limitation, to attach separate parts or pieces to form a shipping container, or to attach portions of a container together, such as to attach a flap or lid to the body of the container. Thus, the presently disclosed shipping assembly further reduces waste, as well as costs, by eliminating the need for the use of packaging tape. Eliminating packaging tape also improves the reusability of a container, which is not damaged by repeated application and removal of packaging tape. The absence of packaging tape may furthermore provide additional exterior container surface area for labeling, marking, advertising and the like.

In some embodiments, the reusable and recyclable shipping assembly of the disclosure may further include, without limitation, an inflatable device that may be used to protect contents of the container from damage during storage or transportation. The inflatable device may be removably attached to the container with fasteners that pass through a flange-like area of the inflatable device. The fasteners may anchor within the wall of the container. In some cases, the removable fasteners will remain connected to the inflatable device after the inflatable device is detached from the box. In other cases, the fasteners are removably attached to the inflatable device and the container. The container, fastener assemblies, inflatable device and fasteners may be made from recyclable materials such that components of the shipping assembly need not be separated or sorted in order to be recycled. In many cases, the entire shipping assembly can be substantially flattened for ease of stacking and storage when not in use.

In further embodiments, the inflatable device is formed from at least two sheets of formable plastic, in which heat seals are configured to seal the sheets together and to form cell-like divisions. The heat seals may be configured to provide a flow path from an inflation point to each cell-like division. Air, nitrogen, or other inert gases may be introduced into the inflatable device and into each cell-like division to form a gas-filled cushion for the contents of the shipping container. In some cases, the heat seals further define a conduit between an inflation point and each cell-like division to facilitate the substantially simultaneous inflation of the cells. Similarly, the heat seals may define a conduit between each cell and a deflation point to facilitate the substantially simultaneous deflation of the cells. In yet other cases, the inflatable device includes check valves between the cells and one or more conduits. In some embodiments, the inflatable device includes without limitation an inflation valve and/or a release valve or deflation valve.

In another aspect, the disclosure includes a method of reusing a recyclable shipping assembly. A shipping assembly is made from recyclable materials and provided to product manufacturers or shipping and delivery services for use together with a data device. The data device is previously associated with data pertaining to that shipping assembly, on or in which the data device is also located. The manufacturers may use the shipping assembly to hold goods that are shipped to a retail location or otherwise transferred to a consumer or end user. The data associated with the data device is detected and used to determine a deposit to be charged for the shipping assembly. This charge is separate from the charge the consumer pays for the product inside the shipping assembly. The transfer of the shipping assembly to the consumer may take place after the money is transferred to a secure merchant account. Subsequently, the consumer removes the goods from the shipping assembly and the shipping assembly is transferred to a service center, optionally with the consumer's contact information. The service center inspects the shipping assembly to determine if the shipping assembly can be reused, or if components of the shipping assembly need to be replaced. If the shipping assembly can be reused, then information regarding its reuse is data that is further associated with the shipping assembly. If the shipping assembly is damaged and cannot be reused or repaired, then the shipping assembly is recycled, and information regarding its disposition is data that is further associated with the shipping assembly. If the shipping assembly needs repair, then information regarding its repair or refurbishment is data that is further associated with the shipping assembly. The service center may optionally send a refund or rebate of the deposit.

In an additional aspect, the disclosure includes a method for processing recyclable materials to recover the materials for reuse for the same function, purpose or use. An item each having unique identifier data are associated with a data device attached to or located in the item. The item is subsequently received at a service center, which logs the receipt of the item using the unique identifier and associates that log information with the unique identifier. The service center inspects the item for its condition and determines whether the item should be reused, repaired, refurbished or recycled. Information regarding the condition and destination of the item is then associated with the unique identifier. If the item can be reused, the reusable items are sorted to return to different manufacturers and shipped. Information regarding where an item has been sent and how many times it has been reused is associated with the unique identifier.

Thus, in one aspect, the invention relates to a reusable packing bag comprising a first outer sheet, a second outer sheet, seals formed between the first and second outer sheets to define one or more chambers having a first end and a second end, a first air passage formed by seals across said first end of said chambers; a second air passage formed by seals across said second end of said chambers; and check valves, disposed between said chambers and said first air passage, and disposed between said second air passage and said chambers. The check valves comprise (a) a lower film located between the first outer sheet and the second outer sheet; (b) an upper film located between the first outer sheet and the lower film; and (c) an intermediate heat-proof member separating the upper film and the lower film. The reusable packing bag further comprises a plurality of spaced apart coupling points disposed within said chambers and further being spaced from the plurality of seals defining each chamber, the coupling points coupling the upper and lower films to each other at each coupling point location, the coupling points further coupling the upper and lower films to the first outer sheet at each coupling point location such that when the bag is under inflation, the lower film and the upper film are urged against the first outer sheet thus blocking air or other inert gas from leaving the chambers; and a plurality of spaced apart coupling points disposed within said second air passage and further being spaced from the plurality of seals defining said second air passage, the coupling points coupling the upper and lower films to each other at each coupling point location, the coupling points further coupling the upper and lower films to the first outer sheet at each coupling point location such that when the bag is under inflation, the lower film and the upper film are urged against the first outer sheet thus blocking air or other inert gas from leaving the chambers.

In one embodiment, an inflation valve is disposed on said bag and in communication with the first air passage. In one embodiment, a deflation valve is disposed on said bag and in communication with the second air passage. In one embodiment, the bad is made of recyclable materials. In one embodiment, the first and second sheet are shaped to form a flange external to said chambers and first and second air passages.

In another aspect, the invention relates to a deflation valve comprising a base and a cap. The base comprises an inner diameter; an outer threaded diameter; and a retention wall. The cap comprises a top having an opening; and threads matching the outer threaded diameter of said base. In one embodiment, the cap is retained by said retention wall or the outer threaded diameter of said base.

In another aspect, the invention relates to a fastener assembly comprising a first fastener insert assembly comprising a top and a bottom, said bottom having a cylinder with a curved flange over a portion of its inner circumference; and a second fastener insert assembly. The second fastener insert assembly comprises a first retention ring; a second retention ring; and an interlocking unit having a curved flange comprising a mating surface with a surface of the curved flange of the first fastener insert assembly. The first and second retention rings are configured to permit movement of said interlocking unit between said rings.

In one embodiment, the interlocking unit rotates around its central axis when contained between the first and second retention rings. In one embodiment, the first fastener insert assembly further comprises a stop on said bottom to limit the travel of the interlocking unit. In one embodiment, the second fastener insert assembly comprises markings indicating the open and closed positions of said fastener assembly.

In another aspect, the invention relates to a reusable container assembly comprising a container with a first wall and a second wall, said walls configured to retain mating parts of a fastener assembly; and a fastener assembly.

In another aspect, the invention relates to a reusable shipping assembly comprising a container assembly comprising a container with a first wall and a second wall, said walls configured to retain mating parts of a fastener assembly; a fastener assembly; and a reusable packing bag removably attached to the container. The fastener assembly comprises a first fastener insert assembly comprising a top and a bottom, said bottom having a cylinder with a curved flange over a portion of its inner circumference; and a second fastener insert assembly. The second fastener insert assembly comprises a first retention ring; a second retention ring; and an interlocking unit having a curved flange comprising a mating surface with a surface of the curved flange of the first fastener insert assembly. The first and second retention rings are configured to permit movement of said interlocking unit between said rings. The reusable packing bag comprises a first outer sheet; a second outer sheet; seals formed between the first and second outer sheets to define one or more chambers having a first end and a second end; a first air passage formed by seals across said first end of said chambers; a second air passage formed by seals across said second end of said chambers; check valves, disposed between said chambers and said first air passage, and disposed between said second air passage and said chambers. The check valves comprise a lower film located between the first outer sheet and the second outer sheet; an upper film located between the first outer sheet and the lower film; and an intermediate heat-proof member separating the upper film and the lower film. The reusable packing bag further comprises a plurality of spaced apart coupling points disposed within said chambers and further being spaced from the plurality of seals defining each chamber, the coupling points coupling the upper and lower films to each other at each coupling point location, the coupling points further coupling the upper and lower films to the first outer sheet at each coupling point location such that when the bag is under inflation, the lower film and the upper film are urged against the first outer sheet thus blocking air or other inert gas from leaving the chambers; and a plurality of spaced apart coupling points disposed within said second air passage and further being spaced from the plurality of seals defining said second air passage, the coupling points coupling the upper and lower films to each other at each coupling point location, the coupling points further coupling the upper and lower films to the first outer sheet at each coupling point location such that when the bag is under inflation, the lower film and the upper film are urged against the first outer sheet thus blocking air or other inert gas from leaving the chambers.

In one embodiment, the assembly further includes a deflation valve disposed on said reusable packing bag. In one embodiment, assembly further comprises a data device situated on or in said container. In one embodiment, the container assembly comprises at least two parts connected by fastener assemblies.

In another aspect, the invention relates to a method of reusing a shipping assembly. The method comprises placing a data device on or in a container of a shipping assembly; detecting data pertaining to said shipping assembly using a data device situated on or in said container; using said data to determine a first amount of money charged for transfer of the shipping assembly to a consumer; transferring said shipping assembly to the consumer, optionally after transfer of said first amount of money to a secure merchant account; receiving said shipping assembly from the consumer, optionally with contact information for said consumer; examining said shipping assembly and (a) revising said data pertaining to the shipping assembly to indicate reuse if it is in condition to be reused; or (b) sending said shipping assembly to be recycled if it is not in condition to be reused, optionally with revision of said data pertaining to the shipping assembly to indicate no reuse or recycling; or (c) replacing damaged portions of the shipping assembly, optionally with revision of said data pertaining to the shipping assembly to indicate repair. The method further comprises optionally sending a second amount of money to said consumer.

In one embodiment, the data device is placed on or in a container of a shipping assembly. In one embodiment, the data device is placed on or in a container of a container assembly.

In another aspect, the invention relates to an air bladder valve arrangement comprising a tube having a cavity therein, the cavity having a plurality of chambers, each chamber being associated with one or more air bladder chambers; a stem positioned within the tube, the stem having a plurality of plungers, each plunger being positioned within a chamber of the cavity of the tube, each plunger being configured to selectively open and close communication of air between adjacent chambers of the cavity of the tube. The stem is movable relative to the tube to position each of the plurality of the plungers to selectively open and close communication of air between adjacent chambers.

In one embodiment, adjacent chambers are connected by an inter-chamber channel, and wherein the plungers are configured to open and close communication of air through the inter-chamber channel. The inter-chamber channel may include a beveled portion, and the plunger may include a cone-shaped head to engage the beveled portion to form a seal to close communication of air between adjacent chambers.

In one embodiment, the air bladder valve arrangement further comprises an end cap arrangement configured to allow air to be transmitted into or out of the cavity of the tube when communication of air between adjacent chambers is open.

In one embodiment, air bladder valve arrangement further comprises a resilient member configured to bias the tube and stem to close communication of air between adjacent chambers.

In one embodiment, the air bladder valve arrangement further comprises a securing arrangement configured to selectively secure the tube and stem to each other to either open or close communication of air between adjacent chambers.

### BRIEF DESCRIPTION OF THE DRAWINGS

FIG. 1 shows a pattern for a container designed to hold a laptop computer;

FIG. 2 shows a pattern for a container designed to hold a computer processing unit;

FIG. 3 shows a pattern for a container designed to hold a flat screen television;

FIG. 4 shows a heat seal connecting portions of a container;

FIG. 5 shows a container with fastener assemblies;

FIG. 6 shows a fastener assembly in an exploded view;

FIG. 7 shows portions of the fastener assembly used to connect container walls;

FIG. 8 shows the fastener assembly connecting two container walls;

FIG. 9 shows an inflatable device;

FIG. 10 shows an end view of an inflatable device;

FIGS. 11A and 11B show a check valve in the inflatable device;

FIG. 12 shows a section view through the attachment of an inflatable device to a container;

FIG. 13A shows a section through a container and an inflatable device;

FIG. 13B shows a section through a container and a partially deflated inflatable device;

FIG. 13C shows a section through a container and a partially deflated inflatable device;

FIG. 14 shows flattened shipping assemblies stacked together;

FIG. 15 shows a deflation valve;

FIG. 16 shows a deflation valve disposed on a portion of an inflatable device;

FIG. 17 shows a section view of the deflation valve;

FIG. 18 illustrates a shipping assembly for a computer processing unit;

FIG. 19 illustrates a shipping assembly for a flat screen television;

FIG. 20 illustrates a shipping assembly for a laptop computer;

FIG. 21 illustrates the progress of a container through one cycle of use;

FIG. 22 illustrates a reusable container;

FIG. 23 illustrates a rebate form;

FIG. 24 illustrates a bladder inflation assembly in accordance with an embodiment of the present invention;

FIG. 25 illustrates an embodiment of a tube of the bladder inflation assembly of FIG. 24;

FIG. 26 illustrates a cross-sectional view of the tube of FIG. 25;

FIG. 27 illustrates a longitudinal cross-sectional view of the tube of FIG. 25;

FIG. 28 illustrates an embodiment of a stem of the bladder inflation assembly of FIG. 24;

FIG. 29 illustrates a detailed view of an end of the stem of FIG. 28;

FIG. 30 illustrates a detailed view of a portion of the stem of FIG. 28;

FIG. 31 illustrates an embodiment of an end-cap assembly for the stem of FIG. 28;

FIG. 32 illustrates a perspective view of an embodiment of an end cap for the end-cap assembly of FIG. 31;

FIG. 33 illustrates a frontal view of the end cap of FIG. 32;

FIG. 34 illustrates a coil spring of the end-cap assembly of FIG. 31; and

FIG. 35 illustrates an embodiment of a housing for the end-cap assembly of FIG. 31.

### DETAILED DESCRIPTION OF THE PREFERRED EMBODIMENTS

Known recycling methods and systems focus on the collection of used packaging materials to be reused as raw materials for new packaging or for entirely different applications. For example, it has been reported that polyethylene bags and reclaimed wood can be reconstituted together to create useful decking and fencing products. Lawn furniture can reportedly be made from “post-consumer” plastic products, such as milk jugs. While such efforts are laudable, in these recycling efforts the “post-consumer” plastic products, for the most part used only once by the consumer, are collected as for recycling, namely reprocessing scrap and waste into a different product. In contrast, the shipping assemblies in accordance with embodiments of the present invention are designed for multiple uses to ship or transport contents prior to recycling, thereby improving the useful life of the assemblies before recycling and transforming the materials into the same or different products. Because the shipping assemblies of the present invention comprise components that may be, in turn, made from recyclable materials, it is possible that one or more components may differ in the number of times the component is reused before recycling.

As described herein, the disclosure includes recyclable shipping assemblies having an interior compartment to hold goods and an exterior for packaging, labeling or branding when the shipping assemblies are closed and methods of using these shipping assemblies. In some embodiments, the shipping assemblies of the disclosure may be completely made from recyclable materials. Non-limiting examples of materials include paper, and plastics, including without limitation nylon, polyethylene terephthalate, high density polyethylene, polyvinyl chloride, low density polyethylene, polypropylene, polystyrene, or combinations thereof. In some cases, the shipping assemblies are primarily made from recyclable materials and any material that cannot be recycled may be easily detached or separated from the recyclable portions of the shipping assemblies.

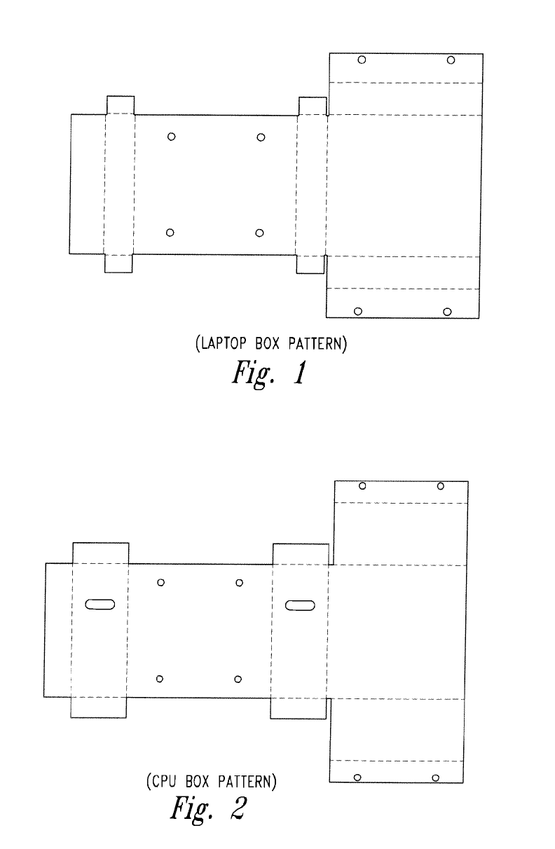

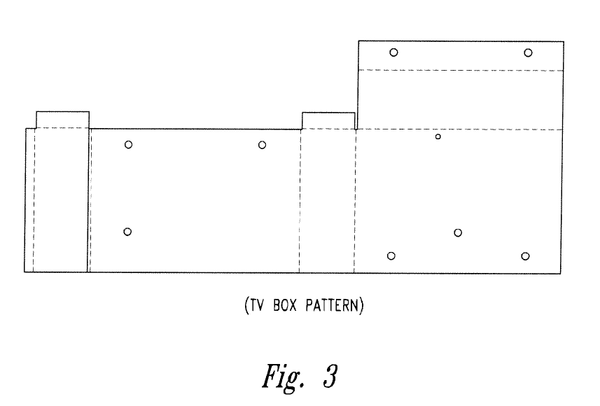

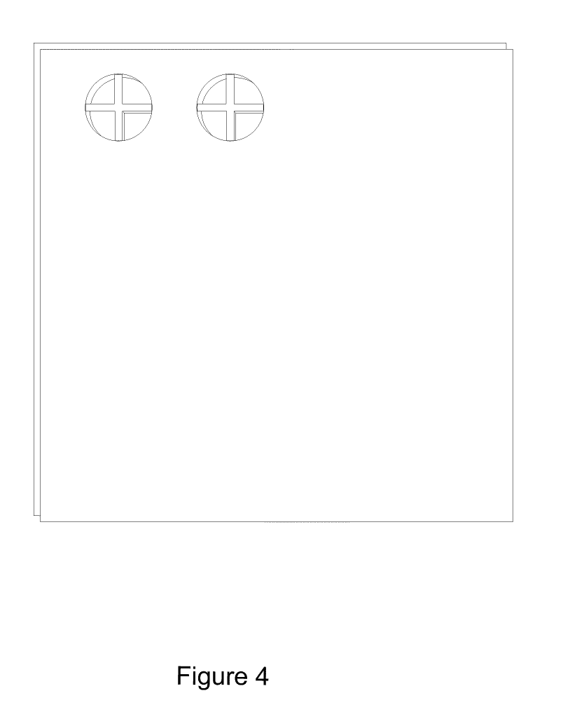

In some embodiments, the shipping assembly includes a container that forms the exterior of the shipping assembly. By way of non-limiting examples, the container may be in the shape of a rectangular box, round or ovoid cylinders, or an envelope. Of course, the shape of the container may be designed to reflect the shipped contents and, therefore, the size and shape are limited only by manufacturing methods as come within known or customary practice within the art to which the disclosure pertains. In some cases, the container may comprise one or more formed parts. In other cases, the container may be created by folding together one or more flat patterns such as those shown in FIGS. 1-3. As seen in these examples, the flat patters may include folds and cutouts for holes, handles and the like. In such cases, the joints of each folded flat pattern may be glued together. In other cases, the joints may be welded or laminated together with applied heat. In yet other cases, the joints may be secured together with adhesive and/or heat, with or without externally applied pressure. The joints need not be continuous along the length of the joint, and spot welds may also be used. FIG. 4 is a photograph that illustrates an example of a heat weld attaching two walls of a container.

In many embodiments, the container will be folded together from a single flat pattern that comprises a closure flap for the container. The closure flap is used to open and close the container to put in or take out contents or other shipping assembly components. The closure flap therefore comprises a portion of the container that is secured to another portion of the container when the container is in a closed position. Non-limiting examples of closure means include hook and loop fasteners, snap fasteners, and other fastener assemblies.

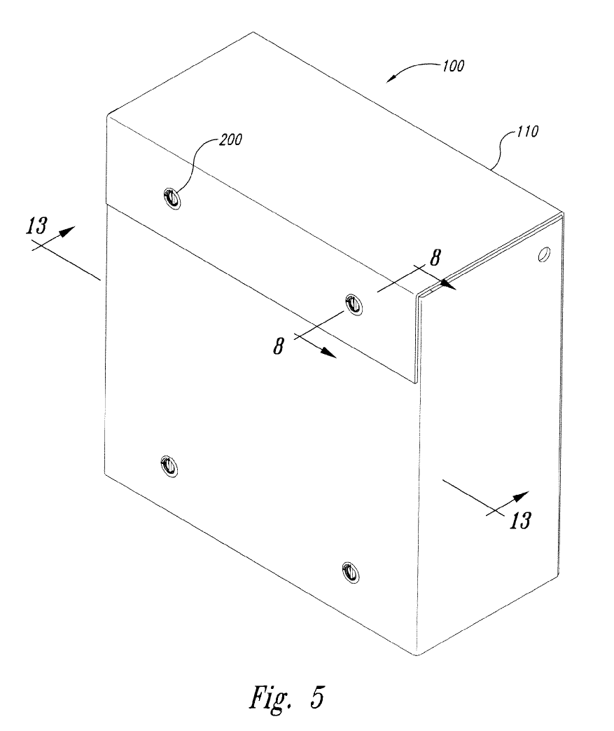

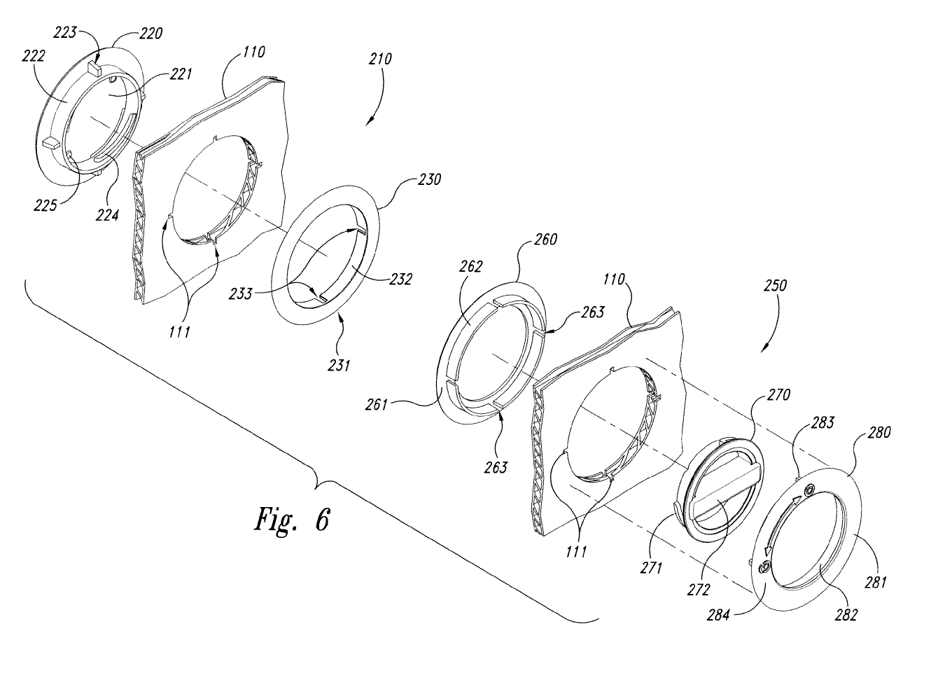

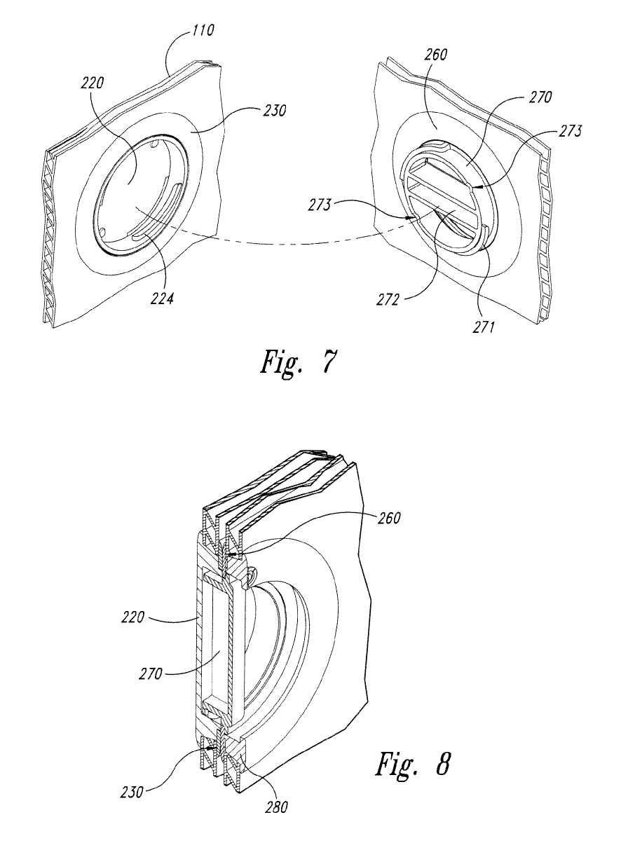

In some embodiments, a container assembly comprises a container with a first wall and a second wall with a portion of a fastener assembly embedded in each wall. The walls may be configured to retain mating parts of a fastener assembly. The fastener assembly can be used to connect any two walls of a container, a closure flap to a container wall, or the walls of two different container parts. FIG. 5 shows a closed container assembly 100 in which a closure flap is secured to the rest of the container 110 with at least one fastener assembly 200. The fastener assembly 200 is shown in FIG. 6 in an exploded view. The fastener assembly may comprise a first female fastener insert assembly 210 and a second male fastener insert assembly 250, each of which may be disposed or embedded in a wall of container 110 as show in FIGS. 7 and 8. Female fastener insert assembly 210 comprises a bottom 220 and top 230. Bottom 220 comprises base 221, cylinder 222, protrusions 223, threads or a curved flange 224 over a portion of the inner circumference of cylinder 222, and stops 225. The stops may be small raised areas on the bottom, or they may be small depressions in the bottom. Top 230 comprises flange 231 and stiffeners 232. Protrusions 223 may assist in the retention of bottom 220 in a first wall of container 110, which may have slits 111 or other openings to accommodate the protrusions. Stiffeners 232 have recesses or cutouts 233 that fit over protrusions 223 when the bottom and top are assembled.

Male fastener insert assembly 250 comprises a first retention ring 260, a second retention ring 280, and an interlocking unit 270. First retention ring 260 comprises a flange 261 and stiffener 262. Second retention ring 280 comprises flange 281, cylinder 282, and protrusions 283. Stiffeners 262 have recesses or cutouts 263 that fit over protrusions 283 when the retention rings are assembled. Interlocking unit 270 comprises threads or a curved flange 271, configured to include a mating surface matching the surface of the curved flange or threads 224 of the first fastener assembly, a handle 272, and detents 273. Optionally, second retention ring 280 includes markings 284 on flange 281 that show the direction handle 272 should be turned to lock or unlock the fastener assembly, or to indicate the open and closed positions of the fastener assembly. The retention rings 260 and 280 are configured to permit movement of interlocking unit 270 between the rings. The interlocking unit 270 rotates around its central axis when contained between the first and second retention rings. The fastener assembly may be closed by twisting handle 272 around a central axis to engage the threads 271 with threads 224 in the female fastener insert. Handle 272 may be turned in a clockwise or a counterclockwise direction to open or close the fastener assembly depending on the direction of the threads 224 and 271. When turning towards the closed position, handle 272 may be turned until detents 273 engage stops 225 in a locked position. The detent and stop arrangement limits the travel of the interlocking unit and assists in securing the fastener assembly in a locked position, and may be designed to produce an audible click or snap when the assembly is locked, or when sufficient force is applied to handle 272 to overcome the arrangement. In the alternative, the detent and stop arrangement may be designed to provide a tactile feedback when the assembly is moved in and out of the locked position.

As described herein, fastener assemblies made from recyclable materials may be used in lieu of or in addition to conventional packing tape or glue to fasten together portions of boxes and shipping containers, thereby reducing disposable waste and increasing the reusability of the container assembly.

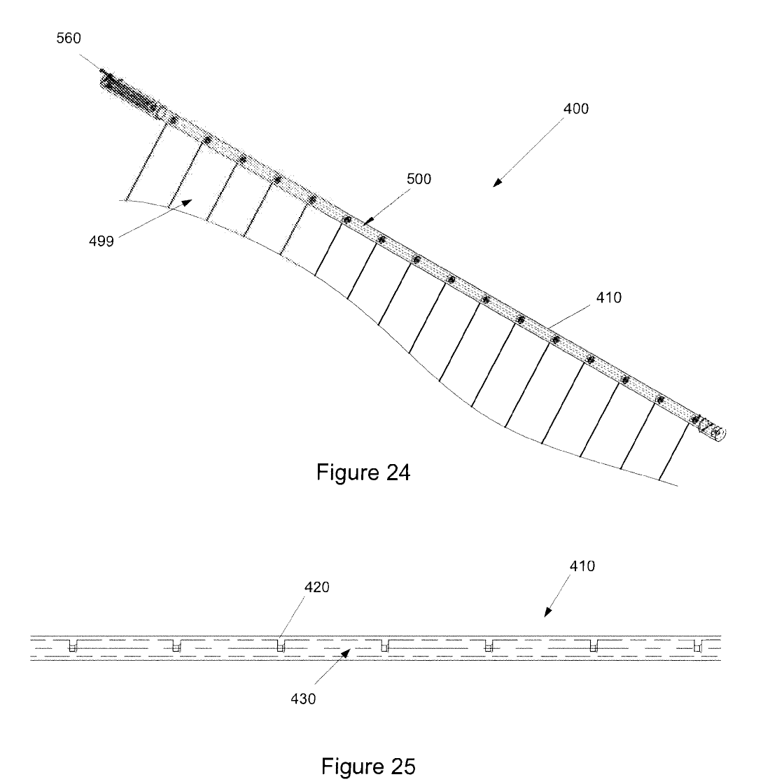

In yet other embodiments, the shipping assembly comprises an inflatable device that protects the contents of the shipping container from damage during handling and shipment. One such inflatable device is described in U.S. Pat. No. 7,201,273, which is hereby incorporated by reference as if fully set forth. Further, an inflatable bladder assembly in accordance with embodiments of the present invention is described below with reference to FIGS. 24-35.

The inflatable device may be made from recyclable materials and may be used as a reusable packing bag in the shipping assembly. The inflatable devices may include, without limitation, an inflation valve and a deflation valve, multiple cells or chambers formed by heat seals and subject to inflation and deflation, and internal check valves between the chambers and air passage conduits. In some embodiments, the inflatable device will include a first and second outer sheet with seals formed between the first and second outer sheets to define one or more chambers having a first and a second end; a first air passage formed by seals across said first end of said chambers; a second air passage formed by seals across said second end of said chambers; check valves disposed (i) between said chambers and said first air passage and (ii) between said second air passage and said chambers, said check valves comprising (a) a lower film located between the first outer sheet and the second outer sheet, (b) an upper film located between the first outer sheet and the lower film, and (c) an intermediate heat-proof member separating the upper film and lower film; a plurality of spaced apart coupling points disposed within said chambers and further being spaced from the plurality of seals defining each chamber, the coupling points coupling the upper and lower films to each other at each coupling point location, the coupling points further coupling the upper and lower films to the first outer sheet at each coupling point location such that when the bag is under inflation, the lower film and the upper film are urged against the first outer sheet thus blocking air or other inert gas from leaving the chambers; and a plurality of spaced apart coupling points disposed within said second air passage and further being spaced from the plurality of seals defining said second air passage, the coupling points coupling the upper and lower films to each other at each coupling point location, the coupling points further coupling the upper and lower films to the first outer sheet at each coupling point location such that when the bag is under inflation, the lower film and the upper film are urged against the first outer sheet thus blocking air or other inert gas from leaving the chambers.

In some embodiments, the inflatable device includes an inflation valve disposed in the device and in communication with the first air passage. In other embodiments, the inflatable device includes an inflation valve disposed in the device and in communication with the second air passage. In yet other embodiments, the sheets of the inflatable device are formed or cut to include a flange that is external to the chambers and the air passages.

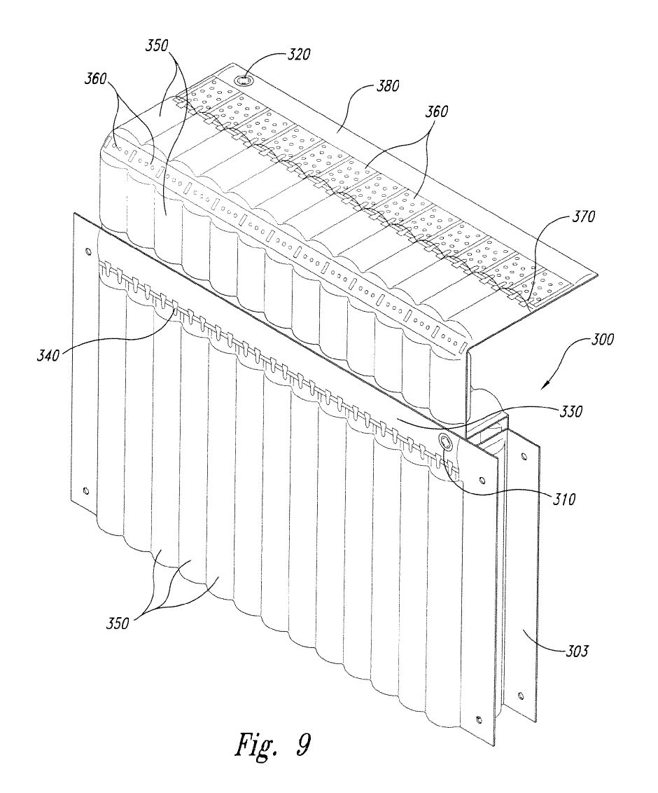

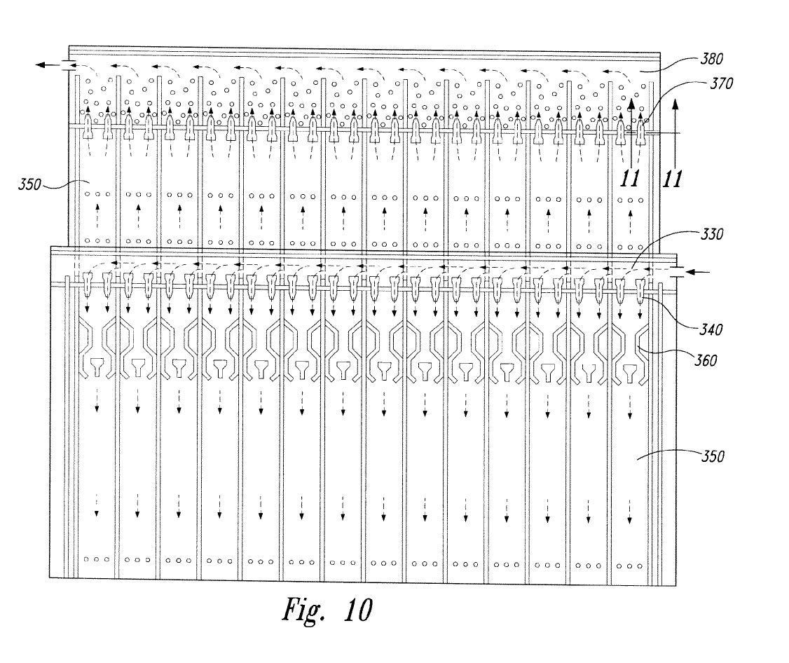

FIG. 9 shows an example of an inflatable device designed to protect laptop computers and their components from damage during shipping and handling. Referring to FIGS. 9 and 10, the reusable packing bag 300, comprising a first outer sheet 301 and a second outer sheet 302, is shown with inflation valve 310 and deflation valve 320 in communication with the first and second air passage respectively. The first outer sheet 301 and second outer sheet 302 may extend past the air chambers to create flange 303, which may be used to attach the device to a shipping container. Air enters inflation valve 310 and travels down air passage 330 before passing through a set of first internal check valves 340 and entering chambers 350. Chambers 350 may be folded and may also include heat seals 360 as shown in FIGS. 9 and 10.

During inflation, internal valves 340 permit air to enter chambers 350, and subsequently, the check valves prevent air from traveling back into air passage 330. Similarly, second internal valves 370 permit air to leave chambers 350, but prevent air from traveling back into chambers 350. When the deflation valve 320 is moved into an open position, air from chambers 350 travels into second air passage 380 and out of the bag. Additional heat seals 360 may be interposed between chambers 350 and air passage 380 as shown in FIG. 10.

As detailed in FIGS. 11A and 11B, the internal check valves 340 and 370 comprise a lower film 391 disposed between the first outer sheet 301 and the second outer sheet 302, and an upper film 392 located between the first outer sheet 301 and the lower film 391, and an intermediate heat-proof member separating upper film 392 and lower film 391 at spaced apart coupling points. The intermediate heat-proof member creates a gap in the heat seal that allows air to travel from the first air passage to the chambers and from the chambers to the second air passage. Under inflation, however, the films 392 and 391 push against one of the outer sheets, effectively blocking the air flow path created by the intermediate heat-proof member and preventing air from leaving a chamber.

The inclusion of a second set of internal check valves 370 allows the air in multiple chambers to be released substantially simultaneously into second air passage 380 when the bag is deflating. This improvement speeds up the time required to deflate the bag. After the bag is deflated, the improved bag may also be readily reused, alone or attached to a shipping assembly, by moving the deflation valve 320 to a closed position and inflating the bag using inflation valve 310. Valves 320 and 310 are disposed on the bag in locations that permit access when the bag is attached to a box or container.

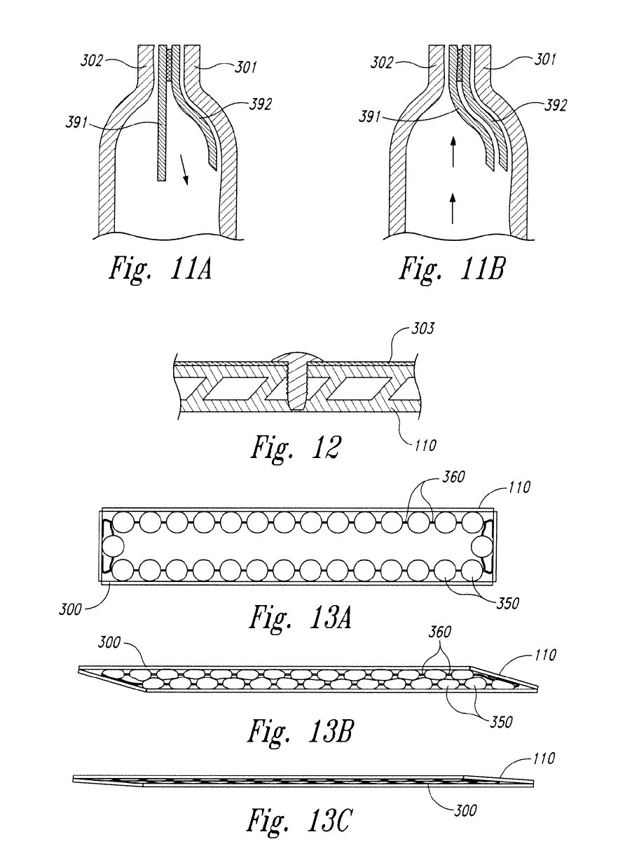

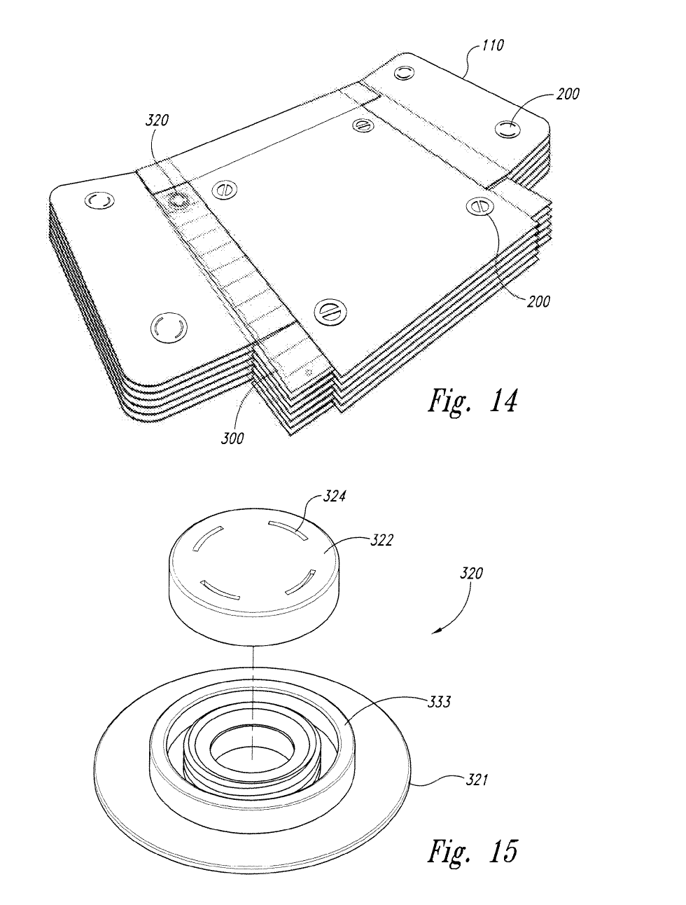

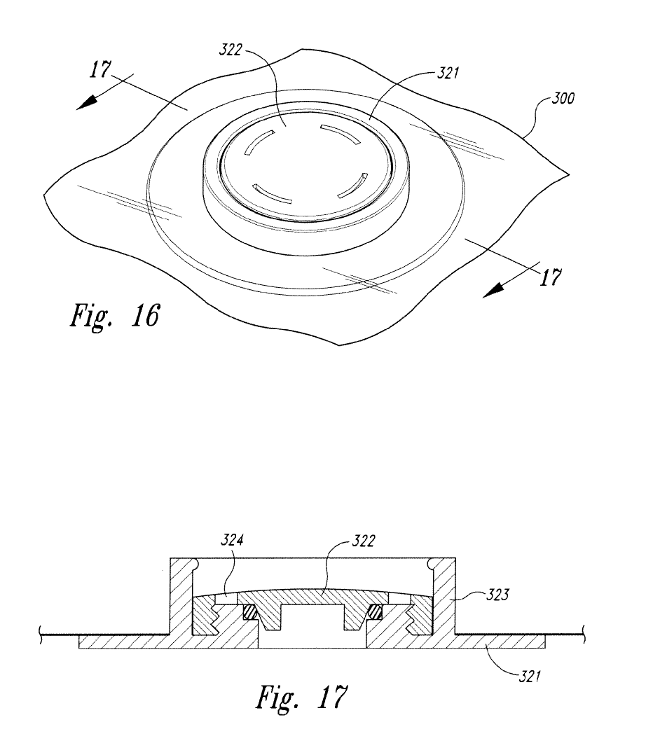

In FIGS. 15-17, flange 303 may be used to attach the bag to a shipping assembly or container. Non-limiting examples of attachment include adhesives, hook and loop fasteners, heat bonding, clips, and fasteners. In FIG. 12, an inflatable device is attached to container 110 using a fastener that anchors within the wall of the container. The fasteners may be removable to permit the substitution of fasteners or inflatable devices within the container.

Deflation valve 320 may comprise a base 321 comprising an inner diameter, an outer threaded diameter and a retention wall 333, and a cap 322 comprising a top having an opening 324 and threads that match the outer threaded diameter of the base. Cap 322 may be moved from a closed position that blocks air from moving through the valve and an open position that lets air to pass through opening 324. In a closed position, as seen in FIG. 17, openings 324 are closed against base 321, thereby preventing air from flowing through the deflation valve.

The design of the inflatable device allows the bag to be stored in a deflated condition together with container 110, as shown in FIGS. 13A-13C and 14. The use of the attached inflatable device saves time required to separately process the shipping assembly components and saves the expense of punctured bags.

The shipping assemblies of the present invention are designed for repeated reuse as shipping and packaging materials prior to recycling. Components of the shipping assemblies may be repaired or replaced before, during or after each cycle of use. The useful lives of shipping assemblies of the present invention may be extended by providing and tracking reusable shipping assemblies that are designed to be used multiple times for the same or substantially similar purpose or function before the shipping assemblies are recycled. Data regarding the shipping assemblies may be collected during each use of the shipping assemblies by a manufacturer or a consumer. Data devices may be used to identify the location of the shipping assemblies, the manufacturer using the shipping assemblies, the consumer using the shipping assemblies, and the deposit charge for the shipping assemblies. The condition of the shipping assemblies after each use is reviewed, collected and analyzed to determine the disposition of the shipping assemblies.

In many embodiments, each shipping assembly includes a data device that is situated on or in the container. The data device may comprise or store data that is associated with each container or shipping assembly. Non-limiting examples include labels, universal product codes (UPCs), stamps, ink stamps, screen prints, silkscreen prints, heat shrinkable polymer or plastic wrapping, bar codes, radio frequency identification (RFID) tags, electronic tags and non-volatile flash memory devices such as memory cards and flash drives and combinations thereof. In many cases, the data devices may also include other information or decoration such as numbers, letters, words, symbols, figures, designs, pictures and logos as non-limiting examples. Each container may include one or more than one data device. Of course, the present invention is intended to cover any tracking devices or data devices as come within known or customary practice within the art to which the disclosure pertains and as may be applied to the invention.

In some cases, the data devices may be mounted onto an interior or exterior surface of the container with adhesive or with fasteners. In other cases, the data devices are printed, stamped or pressed directly onto an interior or exterior surface of the container. In alternative cases, the data devices may be partially or completely implanted within a portion of the container, such as within a wall of the container. In yet other cases, the data devices may be shrink wrapped onto a portion of the container. In some cases, the data device may be attached to an object that is connected to the container. Non-limiting examples may include a label attached to a paper or plastic tag that is connected to the container with a plastic or cable tie.

In many embodiments, data pertaining to each container or shipping assembly is associated with at least one data device located or situated on or in the container. Non-limiting examples of data pertaining to a container or shipping assembly include a unique identifier, the amount of a deposit to be charged to the consumer for the shipping assembly, the number of times or cycles the shipping assembly has been used, the names of product manufacturers that have used the shipping assembly, the name and contact information for each consumer that paid a deposit for the shipping assembly, the amount of any money returned to each consumer, locations where the shipping assembly has been and the amount and kind of damage experienced by the shipping assembly.

In some cases, the data device itself comprises the data pertaining to the container or shipping assembly. As a non-limiting example, the data device may comprise a label numbered with a unique identifier. In another example, the data device may comprise a bar code that, when read or scanned, corresponds to a unique identifier for the container or the amount of a deposit to be charged for the container or shipping assembly. In yet another example, the data device may comprise shrink wrap over a portion of the container that displays the actual amount of a deposit to be charged for the container. In other cases, the data device contains or stores data pertaining to the container or shipping assembly. As a non-limiting example, the data device may comprise an RFID tag that stores a unique identifier for the container or shipping assembly, the amount of a deposit to be charged for the container or shipping assembly, and the location where the sale took place. The number of kinds and types of data pertaining to the container or shipping assembly that are stored on the data device may be limited only by the storage capabilities of the data device. In yet another case, the data device contains or comprises unique identifier data, which is in turn associated with other data pertaining to the container or shipping assembly in databases, spreadsheets or other data files, as non-limiting examples. Data pertaining to the container or shipping assembly then may be accessed by using the unique identifier to locate data associated with the data device. As a non-limiting example, the unique identifier can be read at the point of sale and used to locate the first amount of money to be charged for the container or shipping assembly.

In many cases, the data device may include or be associated with product and other data. As a non-limiting example, a manufacturer's UPC code may be associated with information pertaining to the product in the container as well as with unique identifier data for the container and/or an amount to be charged to the consumer for the container or shipping assembly. In this case, the data pertaining to the container or shipping assembly may be associated with the data device through a third-party UPC code, and the UPC code can be used to detect or access data, such as unique identifier data, pertaining to the container or shipping assembly.

Data pertaining to a container or shipping assembly may be detected visually if the nature and location of the data device permits visual inspection. In many cases, the data device must be read by a sensor, reader or scanner designed to read bar codes, UPCs, RFID tags and non-volatile flash memory devices. The data stored in a data device may be subsequently used to detect data pertaining to a container or shipping assembly stored in databases, spreadsheets or other data files, as non-limiting examples. A computer system may be used to look up the data pertaining to a container or shipping assembly using the data obtained from a data device.

In many embodiments, the container or shipping assembly, which optionally contains one or more products or goods, is transferred to a consumer or end user. In some cases, the container or shipping assembly may be given to a consumer at a point of sale in connection with the consumer's purchase of the products or goods. Non-limiting examples of a point of sale include retail and wholesale stores, outlets, distribution centers, warehouses and electronic commerce websites. The consumer may be required to pick up the container or shipping assembly at a physical location, such as a warehouse or distribution center that is separate from the point of sale where the purchase is made. Alternatively, the container or shipping assembly may be transferred to the consumer via a delivery or shipping service in connection with the consumer's purchase.

In most embodiments, the consumer at the point of sale will pay for the products or goods in the recyclable container, at which time the consumer is also charged a first amount of money for the container or shipping assembly. The consumer may pay by cash, credit card or check as non-limiting examples of payment. Of course, the present invention is intended to cover any payment methods as come within known or customary practice within the art to which the disclosure pertains and as may be applied to the invention. The amount paid by the consumer may be contained in a data device on the container that is read at the point of sale, as a non-limiting example. In another non-limiting example, data stored on the data device will be used at a retail store to look up the first amount of money to charge the consumer. In many cases, the first amount of money is a deposit for the container or shipping assembly, all or a portion of which is returned, rebated, credited or rewarded back to the consumer when the consumer returns the container or shipping assembly. The deposit therefore serves as an incentive to the consumer to encourage him to return the container or shipping assembly in good condition for reuse. The amount charged for any given container or recyclable item may vary according to the nature and size of the items.

In many embodiments, the first amount of money paid at the point of sale by a consumer is transferred to a separate account that holds funds collected from the deposits paid by consumers for reusable containers and other reusable items. In many cases, the account will be a trust account. In other cases, the account will be a merchant account. In yet other cases, the account may be an escrow account. Optionally, the container may be transferred to the consumer after the first amount of money is deposited into the separate account.

Embodiments of the disclosed method may include providing to the consumer instructions for returning the shipping assembly or container to a service center. In many cases, the instructions will be printed on a form that is placed into the container. The instructions may optionally be printed directly onto a surface of the container. In yet other cases, the instructions will be included in a label or shrink wrap that is placed on an interior or exterior surface of the container.

In other embodiments, the instructions may be included in a rebate form. In many cases, the rebate form may also include a data device associated with unique identifier data. The unique identifier data may be used to obtain or detect data pertaining to the container or shipping assembly. The rebate form may optionally include an area on the form on which the consumer may write his contact information such as name, address, telephone number and electronic mail address so that any refund of a deposit may be returned to him. In other cases, the rebate form may further comprise tracking identifier data that is used by a shipping service to track the container or shipping assembly during transfer from the consumer to the shipping service, from the shipping service to a service centers, and from a service center to a manufacturer. The tracking identifier data may in some cases be obtained by reading or scanning a bar code printed onto the rebate form. In other cases, the data devices of the container and/or the rebate form optionally store or are associated with the tracking identifier data. In yet other cases, the tracking identifier is a numeric, alphabetic or alphanumeric string.

The rebate form may be placed in the container to be transferred to the consumer. Optionally, the rebate form will be printed by the manufacturer and placed into the container together with the manufacturer's goods and products. In some cases, the rebate form may also be attached to the container using a sleeve or envelope that adheres to an exterior surface of the container. The sleeve or envelope is attached to the container on one side and transparent on the other to allow the rebate form to be viewed and to permit the reading of any bar codes and other information on the rebate form through the plastic sleeve. In many cases, the rebate form will also serve as a shipping form used by the shipping service and/or the consumer in transferring the container.

In some embodiments, the instructions may include a listing of steps that the consumer needs to take to return the shipping assembly or container to a service center in order to obtain a rebate, refund or credit of the deposit paid for the shipping assembly or container. The instructions may alternatively use or include a reference to a web site where the consumer may obtain the instructions for returning the container and additional information regarding the deposit and rebate program. The instructions may optionally request that the consumer to return the container to a service center or to contact a shipping service that will pick up the container and deliver it to a service center. In some cases the shipping service maybe provided by commercial shipping companies, such as Federal Express as a non-limiting example. The consumer may be required to provide her contact information to the shipping service, which will forward such information to the service center.

As disclosed herein, embodiments of the method may include service centers that receive containers from the consumers, whether directly or via a shipping service. The service centers may include breakdown and refurbishment centers. In some cases, the containers and shipping assemblies may be received at breakdown centers located in various regional centers throughout the United States. The breakdown centers obtain unique identifier data associated with a container or shipping assembly using the data device on the container and logs the receipt of the shipping assembly in a computer. The breakdown center may examine the shipping assembly for damage and record the presence or absence of damage as data associated with the container's data device and/or with the shipping assembly's unique identifier. The breakdown center may also record additional information, such as, without limitation, the number of times or cycles the shipping assembly, or components of the shipping assembly, have been used, the consumer's contact information, and a second amount of money sent to the consumer.

The breakdown center may flatten the shipping assembly to the extent possible for redistribution to a manufacturer, a refurbishment center or to a recycling facility. The shipping assembly may be collected on pallets prior to shipment. As described herein, the refurbishment centers of the present inventions may receive shipping assemblies from the breakdown center and log the receipt of the assemblies using the data devices on the containers. In some cases, the shipping assemblies may be examined at the refurbishment center to determine if the shipping assembly and its components may be reused and/or repaired, and sorted in accordance with the results of the examination. The breakdown center may replace damaged portions or components of the shipping assembly. In other cases, the shipping assembly may be reused for a predetermined number of uses. The predetermined number of uses is data pertaining to the container that is accessible using the container's unique identifier. If the shipping assembly may be reused, the breakdown center may further determine whether the container should be relabeled for use by a different manufacturer. The container may also be relabeled for use with the same manufacturer as determined by the condition of the label or as determined by manufacturer requirements. The breakdown center revises data associated with the container's data device and with the container's unique identifier to record the disposition of the container, such as, without limitation, reuse, recycle, refurbish or repair.

In some embodiments, a second amount of money is returned to the consumer upon receipt and examination of the shipping assembly at a service center. The service center inspects the condition of the shipping assembly and records the findings, which are associated with the container's data device and unique identifier. In some cases, the service center may determine a second amount of money to be returned to the consumer based upon the first amount of money paid by the consumer less an amount deducted for damage to the shipping assembly. In additional cases, the second amount of money may also be reduced relative to the first amount of money by a handling fee and/or a shipment fee for the consumer's use of a shipping service. Of course, in the alternative the consumer may pay the shipment fee separately and directly to the shipping service. In many cases, the second amount of money is paid to the consumer by the service center using information associated with the rebate form. Such payment may take the form of a check, credit slip or credit to the consumer's credit card account. In other cases, the consumer may be instructed to request payment through a secure Internet web site. The monies used to pay the consumer may be drawn from the secure account.

As described herein, the disclosure includes a method of processing reusable materials using unique identifier data that is associated with each item and a data device situated on or in the item. In some embodiments, a service center logs in the receipt of an item using the unique identifier data. The service center may inspect the item to determine the amount of damage experienced by the item. This information is associated with the item's unique identifier. The service center also revises data pertaining to the item, such as incrementing by one the number of times or cycles the item has been used. The service center may determine whether the item is reusable or whether the item can no longer be used and therefore should be recycled. The service center may also determine that the item requires repair or refurbishment. The disposition of the item is modified in the computing system used by the service center for each item. As a non-limiting example, a reusable item may be directed to a manufacturer based on the number of times or cycles the item has been used, the manufacturer's production requirements and the number of available items at the service center. The service center sorts the reusable items and relabels the items if necessary, and flattens or otherwise prepares the items for redistribution.

Having now generally provided the disclosure, the same will be more readily understood through reference to the following examples which are provided by way of illustration, and are not intended to be limiting of the disclosure, unless specified.

### EXAMPLES

### Example 1

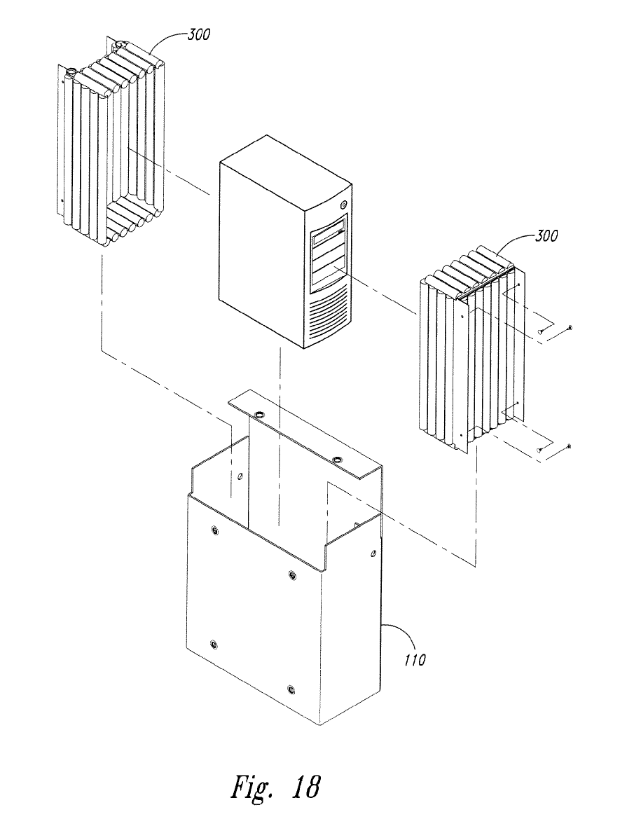

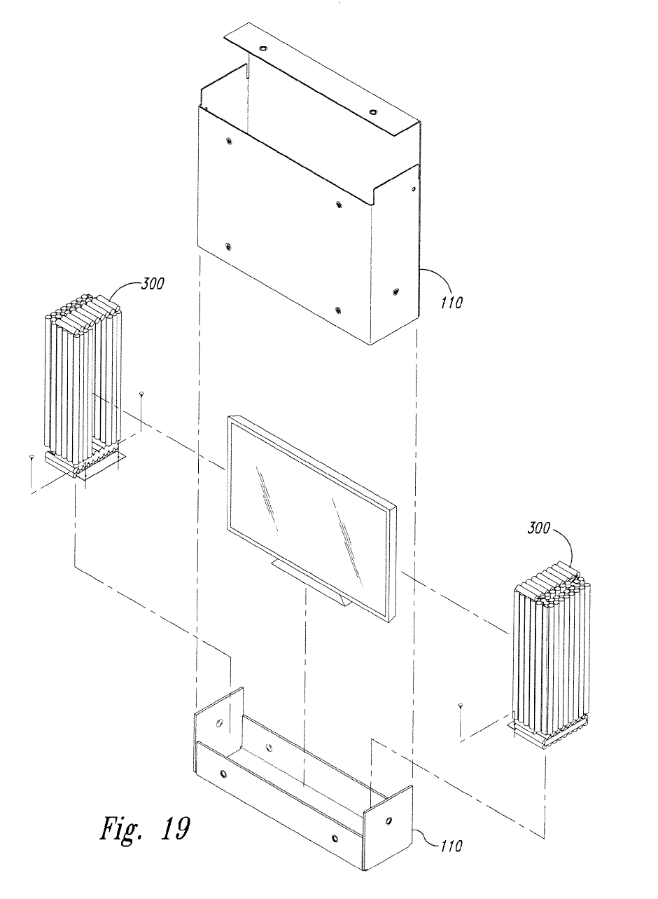

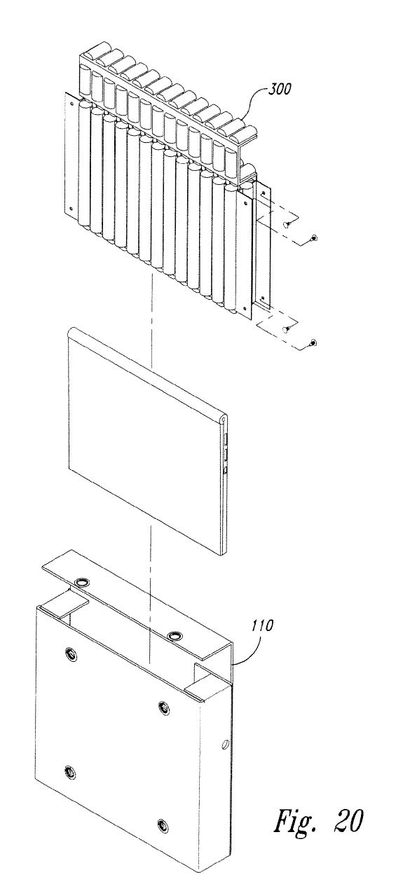

In FIGS. 18-20, a computer processing unit, a flat screen television and a laptop are respectively placed in a shipping container 110 together with one or more inflatable packing bags 300 anchored to the container wall with fasteners.

### Example 2

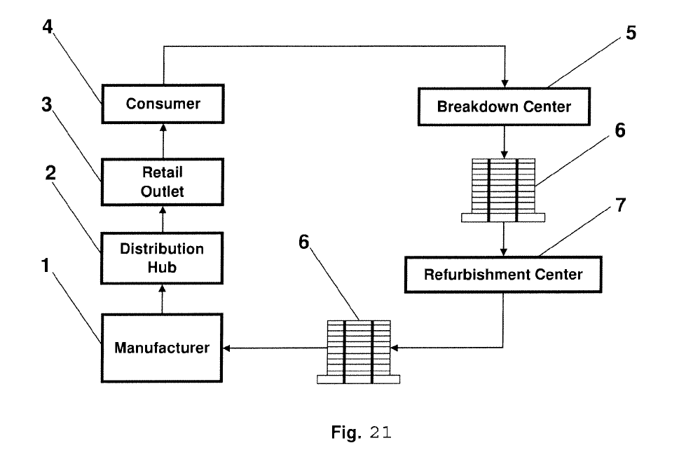

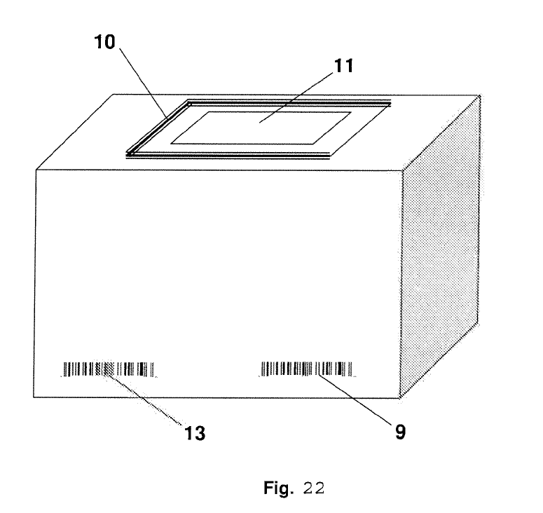

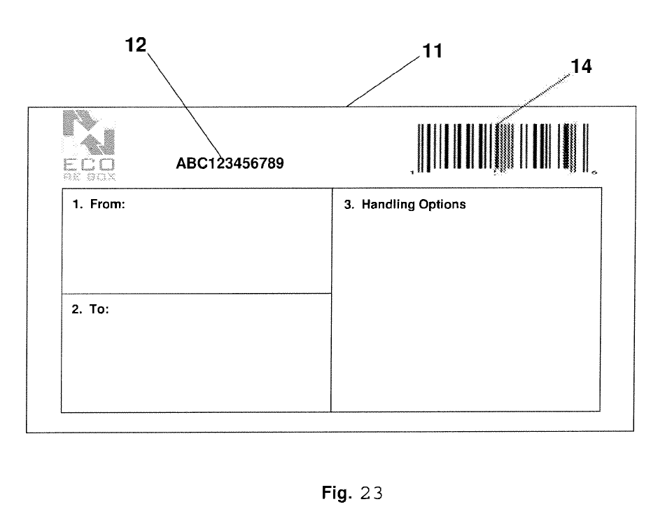

In FIG. 21, box 8 of FIG. 22 made from recyclable materials and designed to hold televisions during shipment is received at manufacturer 1. The box includes bar code labels 9 and 13 on the exterior of the box. The bar code label 9 has been previously associated with unique identifier data that is obtained when the bar code is read or scanned. The bar code label 13 has been previously associated with a deposit amount that should be charged for the box, also obtained when the bar code is read or scanned. The manufacturer 1 scans the bar code on label 9 and prints a rebate form 11 with bar code label 14, which is a duplicate of bar code label 9. The rebate form 11 also includes tracking identifier data 12 as shown in FIG. 23. The rebate form is placed into the box 8 along with an instruction sheet for returning the container. Alternatively, the rebate form may be provided directly to retail outlet 3.

The manufacturer packs a television into box 8 and transfers the television to a distribution hub 2. The television is transferred from distribution hub 2 to a retail outlet 3 through existing distribution channels. Consumer 4 selects the television for purchase and proceeds to the point of sale at retail outlet 3 to pay for the product. At the point of sale, the bar code on label 13 is scanned and the deposit amount is added as an additional charge to the consumer. Consumer 4 pays for both the television and the deposit on the box at the point of sale with a credit card, after which she leaves with the television in its box. Retail outlet 3 transfers the deposit amount to a secure trust account. Retail outlet 3 may optionally scan the bar code on label 9 and forward the unique identifier data to the breakdown center 5 or the refurbishment center 7 to alert the service centers that a deposit has been made.

Consumer 4 removes the television, rebate form 11, instructions and an optional sleeve or envelope 10 from box 8. The instructions indicate that the consumer should (i) call a shipping service for pick up of the box, for which service a fee is deducted from the consumer's deposit; (ii) take the box to an office of the shipping service; or (iii) return the box to a breakdown center 5. The instructions indicate that if the consumer chooses (ii) and (iii), no deductions will be taken from the consumer's deposit. Optionally, the instructions indicate that a handling fee may be deducted from the consumer's deposit.

Consumer 4 calls the shipping service to pick up box 8 and writes her name and contact information on rebate form 11. The shipping service scans in the bar code on label 9 and enters its tracking identifier data 12 into its computer system. The shipping service may optionally determine the closest regional breakdown center 5 and put that location on rebate form 11. The shipping service places the envelope 10, using the adhesive provided on one side of the envelope, onto the exterior of the box and puts rebate form 11 into the envelope, which is transparent on the side facing away from the box. The shipping service may forward the unique identifier data to the breakdown center 5 or the refurbishment center 7 to alert the service centers that box 8 has been picked up. The shipping service uses the tracking identifier data 12 to track the box from the consumer to breakdown center 5 or refurbishment center 7. The shipping service optionally forwards the name and contact information of consumer 4 to breakdown center 5 or refurbishment center 7.

The shipping service optionally may flatten or collapse the box to prepare the box 8 for shipment to breakdown center 5 or the refurbishment center 7. Optionally, the shipping service may collect multiple boxes to ship together. The shipping service may optionally collect the boxes on a pallet 6 prior to shipment, or collect the boxes in a shipping container. Non-limiting examples of shipping containers may include LD2 and LD3 containers or custom containers of a suitable size and dimension to collect multiple boxes.

The breakdown center 5 receives box 8 from the shipping service and scans in the bar code on label 9 or label 13. The breakdown center accesses data pertaining to the box using the unique identifier data and increases the number of cycles that the box has been used by one. The breakdown center logs in the receipt of the box and proceeds to inspect the box for damage. If the box may be reused, either as is or with refurbishment, then the breakdown center may flatten or collapse the box in preparation for shipment with other boxes on pallet 6 to refurbishment center 7. The breakdown center 5 may optionally send the box to a recycling center as scrap if the box cannot be reused. The breakdown center 5 may modify data pertaining to the box and associate that data with the box's unique identifier. The breakdown center 5 or refurbishment center 7 may optionally send a check returning the deposit paid by consumer 4 less a handling fee and less a shipping service fee. Alternatively, breakdown center 5 or refurbishment center 7 may optionally credit the credit card account of consumer 4 in response to an electronic refund request submitted by consumer 4 over the Internet in accordance with the instructions sheet.

The refurbishment center 7 receives box 8 from the breakdown center 5 and scans in the bar code on label 9. The refurbishment center 7 accesses data pertaining to the box using the unique identifier data, including any data that has been modified by the breakdown center 5. The refurbishment center 7 sorts the box 8 according to the information provided by breakdown center 5, or optionally the refurbishment center 7 conducts its own inspection. The refurbishment center 7 may relabel a box for reuse with the same or a different manufacturer. The refurbishment center 7 may designate a box for recycling if the box has reached a predetermined number of cycles of use. The refurbishment center 7 may modify data pertaining to the disposition of the box and associate that data with the box's unique identifier. Refurbishment center 7 sorts box 8 according to the disposition. As an example, the refurbishment center 7 may relabel box 8 for use by manufacturer 1 and collect the box with other boxes on a pallet 6 for shipment to manufacturer 1.

Referring now to FIGS. 24-35, an inflatable bladder assembly in accordance with embodiments of the present invention is described. Referring first to FIG. 24, the inflatable bladder assembly 400 is illustrated with the ability to repeatedly inflate and deflate a series of air bladder chambers 499. The air bladder chambers 499 may be individual and independent chambers, but they may be physically linked to form a single packing cushion. Thus, if one air bladder chamber 499 is punctured, the remaining chambers are unaffected.

In this regard, each chamber is associated with a portion of the inflation/deflation valve mechanism described in greater detail below. Those skilled in the art will understand that the size and number of the air bladder chambers 499 may be varied as required by, for example, packaging requirements.

The inflation/deflation valve mechanism of the inflatable bladder assembly 400 includes an outer tube 410 with an stem 500 inserted therein. As described below, the tube 410 and stem 500 integrate to form a valve system which allows the air bladder chambers 499 to be repeatedly inflated and deflated. In this regard, pressurized air may be directed into and out of the air bladder chambers through an end cap assembly 560 at one end of the valve mechanism.

Referring now to FIG. 25, an embodiment of a tube 410 of the bladder inflation assembly 400 of FIG. 24 is illustrated. In the illustrated embodiment, the tube 410 includes a tube body 420 with an internal tube cavity 430. The outer surface of the tube body 420 has a cylindrical configuration. The tube body 420 may be made out a variety of materials, including various plastic or metals, for example. In one embodiment, the tube body 420 is formed in two longitudinal sections that may be assembled with the stem 500 positioned therebetween.

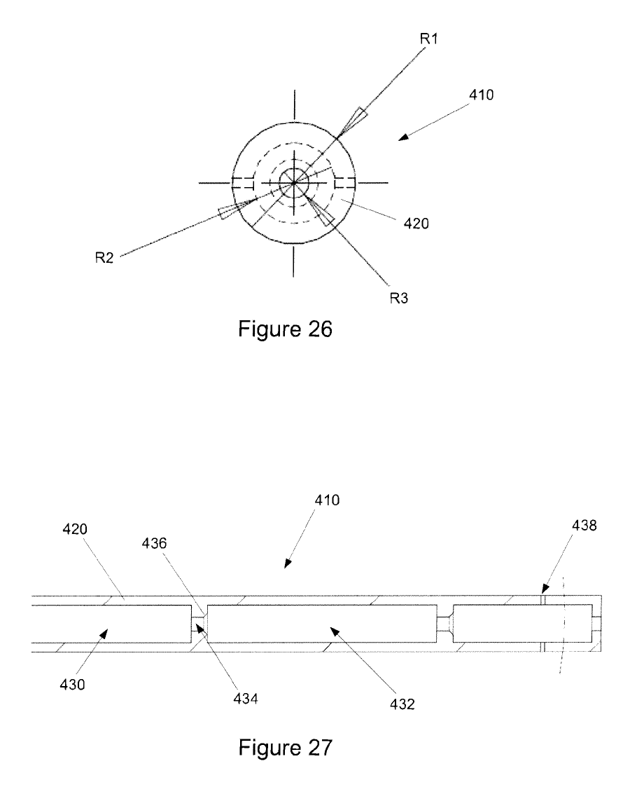

FIG. 26 illustrates a cross-sectional view of the tube 410 of FIG. 25, and FIG. 27 illustrates a longitudinal cross-sectional view of the tube 410. As illustrated in the Figures, the tube body 420 has a cylindrical outer surface and a tube cavity 430 therein. In one embodiment, the cylindrical outer surface of the tube body 420 has a diameter of 9.5 mm. The tube cavity 430 extends substantially through the entire length of the tube body 420 and is divided into a plurality of inflation chambers 432. Each inflation chamber 432 corresponds to an air bladder chamber 499. In other embodiments, each inflation chamber 432 may correspond to a plurality of air bladder chambers. For example, each inflation chamber 432 may be configured to provided a passage for inflation or deflation of two, three or more air bladder chambers. In the illustrated embodiment, each inflation chamber corresponds to exactly one air bladder chamber, and the inflation chambers 432 has a diameter of 6.3 mm.

While not shown in the figures, those skilled in the art will understand that the air bladder chambers may be connected to the tube 410 in a sealed manner, and the air bladder chambers may be in communication with the inflation chambers 432 to allow air to be directed into and out of the air bladder chambers through the inflation chambers 432. Further, one end of the tube 410 includes a securing pin receptacle 438 for securing the stem 500 in either an open or a closed position, as described in further detail below. In the open position, the air bladder chambers may be inflated or deflated, while in the closed position, air cannot flow into or out of the air bladder chambers.

Each inflation chamber 432 is connected to a neighboring inflation chamber 432 through an inter-chamber connector channel 434. The inter-chamber connector channel 434 allows air to flow between the inflation chambers 432 during the inflation and deflation processes. In one embodiment, the inter-chamber connector channel 434 has a diameter of 2.3 mm. On one end, the inter-chamber connector channel 434 includes a beveled portion 436 which transitions to the small diameter of the inter-chamber connector channel. In the illustrated embodiment, the beveled portion has a bevel angle of approximately 45 degrees and a longitudinal length of approximately 0.7 mm.

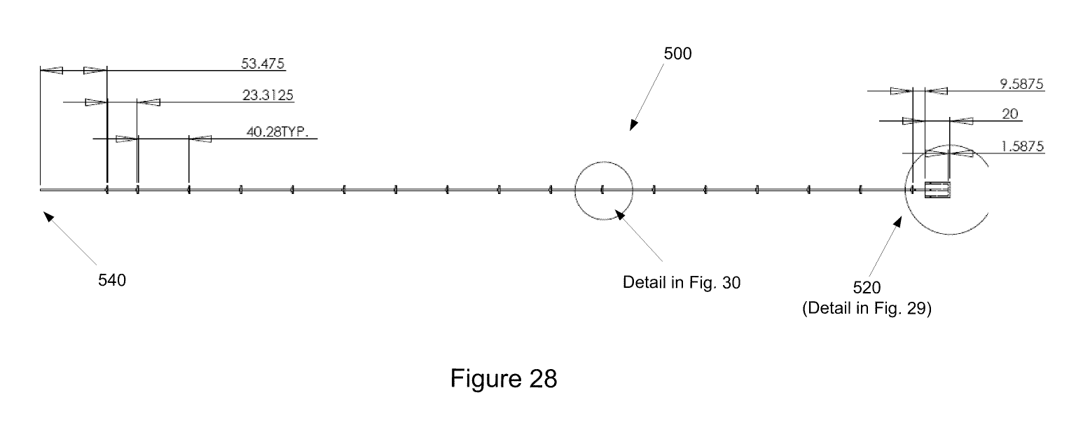

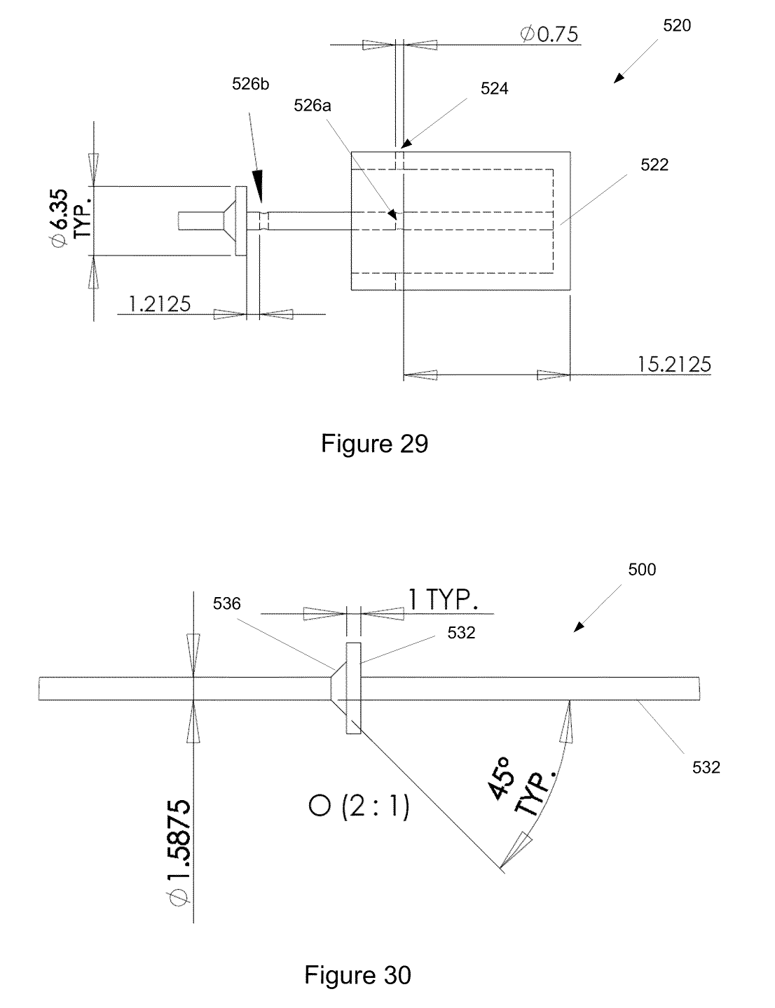

Referring now to FIG. 28, an embodiment of a stem 500 of the bladder inflation assembly 400 of FIG. 24 is illustrated. The stem is configured to be positioned within the tube cavity 430 of the tube body 420 shown in FIG. 27. On one end of the stem 500, an end arrangement 520 is provided to allow the stem 500 to be secured to the tube 410. The end arrangement 520 is described in further detail below with reference to FIG. 29.

The stem 500 is divided into segments corresponding to the inflation chambers 432 of the tube cavity 430 shown in FIG. 27. The segments are divided by plungers that are described in further detail below with reference to FIG. 30.

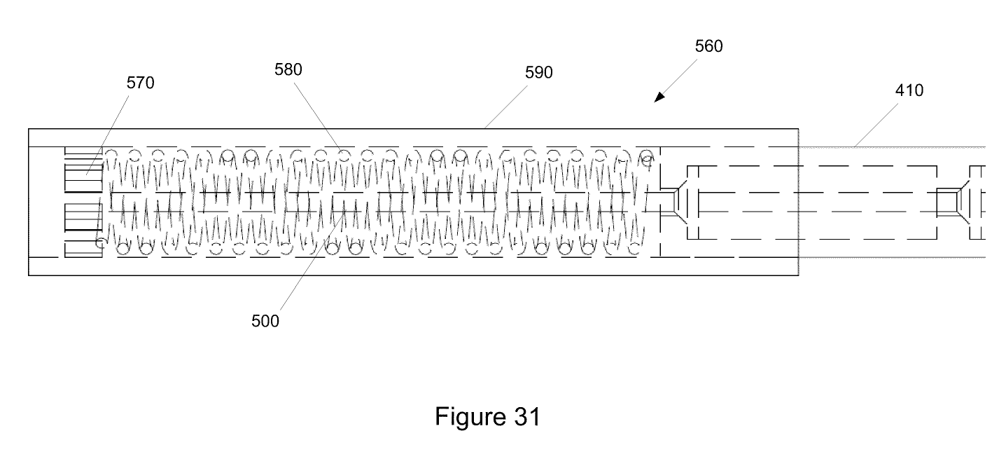

The stem 500 ends at a second end 540, having a length that substantially corresponds to the length of the tube 410. An end-cap arrangement may be positioned at the second end 540 to allow the air bladder chambers to be inflated and deflated. One embodiment of an end-cap arrangement is described below with reference to FIGS. 31-35.

Referring now to FIG. 29, a detailed view of an end arrangement 520 of the stem of FIG. 28 is illustrated. The end arrangement 520 includes an enclosure 522 configured to enclose the end of the tube 410 therein. The enclosure 522 has an open end from which the stem 500 extends outward (to the left in FIG. 29). Further, the enclosure 522 has a closed end (on the right end in FIG. 29). Thus, the end of the tube 410 covering the stem 500 may be inserted into the open end of the enclosure 522. In one embodiment, the enclosure has an outer diameter of approximately 12.7 mm and an inner diameter of 9.5 mm.

The enclosure 522 includes a pin receptacle 524 for receiving a cotter pin therein. The pin receptacle 524 may be aligned with securing pin receptacle 438 of the tube 410 (shown in FIG. 27) and one of two pin through holes 526a, 526b on an end of the stem 500. Thus, with a securing pin inserted, the enclosure 22 serves to secure the tube to the stem. Further, the stem 500 and the tube 410 may be secured either in an open position to allow air to flow through the tube cavity 430 (either for inflation or for deflation) or in a closed position to block such flow of air. In this regard, the pin through hole 526a is used for the closed position, and the pin through hole 526b is used for the open position. This mechanism is described in further detail below.

Referring now to FIG. 30, a detailed view of a portion of the stem 500 of FIG. 28 is illustrated. In this regard, the stem has a shaft portion 532 which extends through substantially the entire length of the tube 410 in which the stem is inserted. In one embodiment, the shaft portion 532 of the stem 500 has a cross-sectional diameter of approximately 1.6 mm. As noted above, the stem 500 is divided into segments corresponding to the inflation chambers 432 of the tube cavity 430. The segments are divided by plungers 534. In the illustrated embodiment, the plungers are disk-shaped protrusions sized to fit within the inflation chamber 432 of the tube cavity 430 (FIG. 27). Additionally, a cone-shaped head 536 is positioned on one side of the plunger 534.

The plunger 534 and the cone-shaped head 536 are sized to engage with the beveled portion 436 and the inter-chamber connector 434 to function as a valve. In this regard, in one embodiment, the plunger has a diameter of 6.3 mm, and the cone-shaped head has a cone angle of 45 degrees to coincide with the 45-degree bevel angle of the beveled portion 436.

Thus, when inflating or deflating the air bladder system, the cotter pin inserted into the pin receptacle 524 of the enclosure 522 and the securing pin receptacle 438 of the tube 410 is removed and re-inserted into the receptacles 524 and 438, as well as pin through hole 526b of the stem 500 (FIG. 29). In this position, in each inflation chamber 432, the plunger 534 is moved away from the beveled portion 436, thereby opening the tube cavity 430 for air flow throughout the tube cavity 430 and into the air bladder chambers 499. Once the inflation or deflation of the air bladder chambers 499 is completed, the system may be closed by removing the pin and reinserting into the receptacles 524 and 438, as well as pin through hole 526a. In this position, the plunger 534 and the cone-shaped head 536 engage the beveled portion 436, thereby blocking air from passing through the inter-chamber connector channels 434. The pin may also server as a means for detecting or deterring tampering by a consumer, for example. In this regard, it may be desirable for only certain entities, such as an authorized center, to be allowed to inflate or deflate the system.

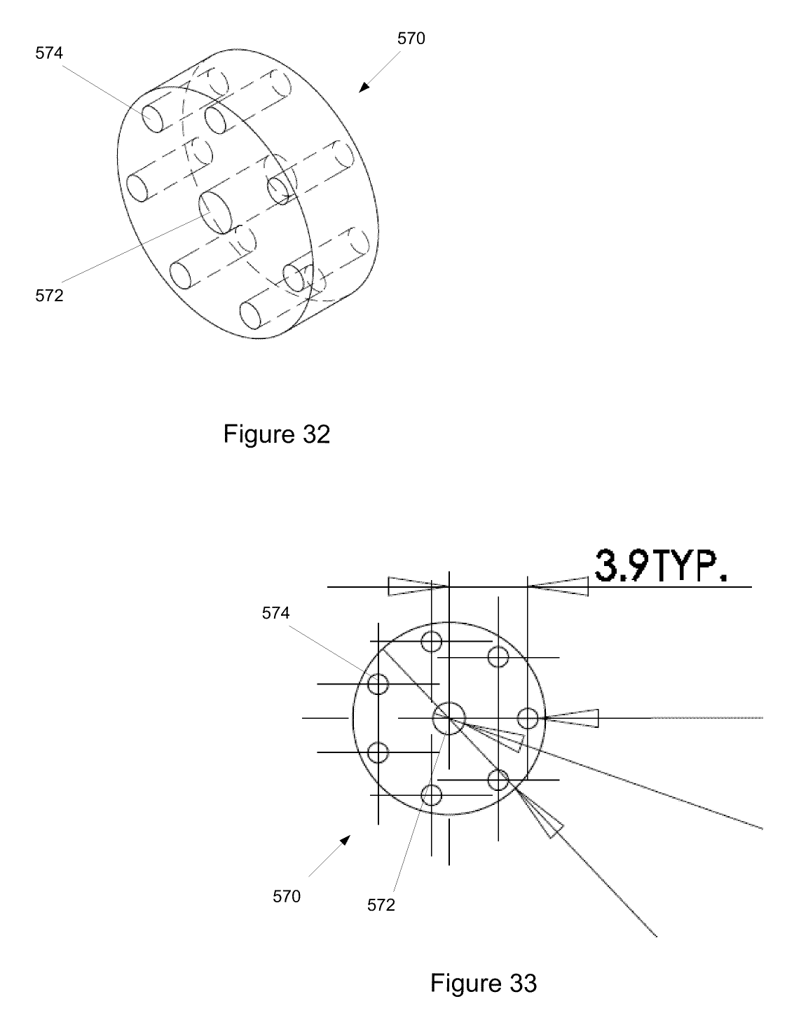

Air may be pumped or directed into or out of the tube cavity 430 during the inflation and deflation processes through an end-cap assembly for the stem 500, an embodiment of which is illustrated in FIG. 31. The illustrated end-cap assembly 560 includes an end cap 570 (described in detail below with reference to FIGS. 32 and 33), a coil spring 580 and a housing 590. The end-cap assembly surrounds the end of the shaft 500, and the housing is sized to accommodate the end of the tube 410 therein.

Referring now to FIGS. 32 and 33, an embodiment of an end cap 570 for the end-cap assembly 560 of FIG. 31 is illustrated. The end cap 570 is a disk having a diameter of approximately 9.5 mm, and a width of approximately 3.2 mm. The end cap 570 includes a central through hole 572 configured to engage the end of the stem 500. A locking mechanism may be provided at the end of the stem to engage and/or lock the stem to the end cap 570 through the central through hole 572. Additionally, the end cap 570 is provided with a series of holes 574 around the perimeter of the end cap 570. Air may be provided to the tube cavity 430 and, therefore, to the air bladder chambers 499 through the holes 574 when the system is in the open position. Of course, air may also be vented through the holes 574 to deflate the air bladder chambers 499.

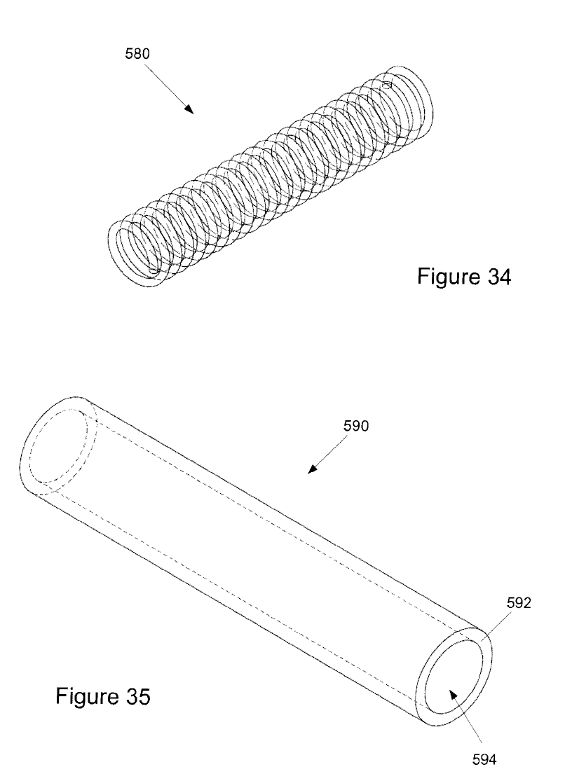

Referring now to FIG. 34, an embodiment of the coil spring 580 of the end-cap assembly 560 of FIG. 31 is illustrated. The spring 580 provides resilience to ensure proper closure of the valve system by biasing the tube 410. In this regard, the beveled portion 436 of the tube cavity 430 is resiliently biased against the plunger 534 of the stem 500 when the system is in a closed position. The length and resilience of the spring 580 may be selected based on design requirements. The diameter of the spring 580 is configured to engage the end of the tube 410.

Referring now to FIG. 35, an embodiment of a housing 590 for the end-cap assembly 560 of FIG. 31 is illustrated. The end cap housing 590 has a cylindrical body 592 and a cylindrical cavity 594 therein. In the illustrated embodiment, the cylindrical body 592 has an outer diameter of 12.7 mm. The cylindrical cavity 594 has a diameter of approximately 9.5 mm, corresponding to the diameter of the tube 410 and the end cap 570. The housing 590 is configured to secure the end cap 570 within the cavity 594 by, for example, integrally forming the combination by injection molding. Of course, other mechanisms of securing the end cap 570 to the cavity 594 will be apparent to those skilled in the art and are contemplated within the scope of the present invention.

All references cited herein, including patents, patent applications, and publications, are hereby incorporated by reference in their entireties, whether previously specifically incorporated or not.

Having now fully described the inventive subject matter, it will be appreciated by those skilled in the art that the same can be performed within a wide range of equivalent parameters, concentrations, and conditions without departing from the spirit and scope of the disclosure and without undue experimentation.

While this disclosure has been described in connection with specific embodiments thereof, it will be understood that it is capable of further modifications. This application is intended to cover any variations, uses, or adaptations of the disclosure following, in general, the principles of the disclosure and including such departures from the present disclosure as come within known or customary practice within the art to which the disclosure pertains and as may be applied to the essential features hereinbefore set forth.

1. An air bladder valve arrangement, comprising:
a tube having a cavity therein, the cavity having a plurality of chambers, each chamber being associated with one or more air bladder chambers;
a stem positioned within the tube, the stem having a plurality of plungers, each plunger being positioned within a chamber of the cavity of the tube, each plunger being configured to selectively open and close communication of air between adjacent chambers of the cavity of the tube,
wherein the stem is movable relative to the tube to position each of the plurality of the plungers to selectively open and close communication of air between adjacent chambers.

2. The air bladder valve arrangement of claim 1, wherein adjacent chambers are connected by an inter-chamber channel, and wherein the plungers are configured to open and close communication of air through the inter-chamber channel.

3. The air bladder valve arrangement of claim 2, wherein the inter-chamber channel includes a beveled portion, and wherein the plunger includes a cone-shaped head to engage the beveled portion to form a seal to close communication of air between adjacent chambers.

4. The air bladder valve arrangement of claim 1, further comprising:
an end cap arrangement configured to allow air to be transmitted into or out of the cavity of the tube when communication of air between adjacent chambers is open.

5. The air bladder valve arrangement of claim 1, further comprising:
a resilient member configured to bias the tube and stem to close communication of air between adjacent chambers.

6. The air bladder valve arrangement of claim 1, further comprising:
a securing arrangement configured to selectively secure the tube and stem to each other to either open or close communication of air between adjacent chambers.

7. An inflatable device for a container, comprising:
a first outer sheet;
a second outer sheet;
seals formed between the first and second outer sheets to define one or more chambers having a first end and a second end;
a first air passage formed by seals across said first end of said chambers;
a second air passage formed by seals across said second end of said chambers; and
one or more check valves disposed between said chambers and said first air passage, and disposed between said second air passage and said chambers.

8. The inflatable device of claim 7, wherein said check valves comprise:
(a) a lower film located between the first outer sheet and the second outer sheet;
(b) an upper film located between the first outer sheet and the lower film; and
(c) an intermediate heat-proof member separating the upper film and the lower film.

9. The inflatable device of claim 7, further comprising:
a plurality of spaced apart coupling points disposed within said chambers and further being spaced from the plurality of seals defining each chamber, the coupling points coupling the upper and lower films to each other at each coupling point location, the coupling points further coupling the upper and lower films to the first outer sheet at each coupling point location such that when the inflatable device is under inflation, the lower film and the upper film are urged against the first outer sheet thus blocking air or other inert gas from leaving the chambers; and
a plurality of spaced apart coupling points disposed within said second air passage and further being spaced from the plurality of seals defining said second air passage, the coupling points coupling the upper and lower films to each other at each coupling point location, the coupling points further coupling the upper and lower films to the first outer sheet at each coupling point location such that when the inflatable device is under inflation, the lower film and the upper film are urged against the first outer sheet thus blocking air or other inert gas from leaving the chambers.

10. The inflatable device of claim 7, further comprising an inflation valve in communication with the first air passage.

11. The inflatable device of claim 10, wherein the inflation valve comprises:
a tube having a cavity therein, the cavity having a plurality of chambers, each chamber being associated with one or more air bladder chambers;
a stem positioned within the tube, the stem having a plurality of plungers, each plunger being positioned within a chamber of the cavity of the tube, each plunger being configured to selectively open and close communication of air between adjacent chambers of the cavity of the tube,
wherein the stem is movable relative to the tube to position each of the plurality of the plungers to selectively open and close communication of air between adjacent chambers.

12. The inflatable device of claim 11, wherein adjacent chambers are connected by an inter-chamber channel, and wherein the plungers are configured to open and close communication of air through the inter-chamber channel.

13. The inflatable device of claim 12, wherein the inter-chamber channel includes a beveled portion, and wherein the plunger includes a cone-shaped head to engage the beveled portion to form a seal to close communication of air between adjacent chambers.

14. The inflatable device of claim 11, further comprising:
an end cap arrangement configured to allow air to be transmitted into or out of the cavity of the tube when communication of air between adjacent chambers is open.

15. The inflatable device of claim 11, further comprising:
a resilient member configured to bias the tube and stem to close communication of air between adjacent chambers.

16. The inflatable device of claim 11, further comprising:
a securing arrangement configured to selectively secure the tube and stem to each other to either open or close communication of air between adjacent chambers.

17. A container assembly, comprising:
a container having a first wall and a second wall;
a fastener assembly having mating parts retained within the first wall and the second wall; and
an inflatable device positioned within the container, the inflatable device comprising:
a first outer sheet;
a second outer sheet;
seals formed between the first and second outer sheets to define one or more chambers having a first end and a second end;
a first air passage formed by seals across said first end of said chambers;
a second air passage formed by seals across said second end of said chambers; and
one or more check valves disposed between said chambers and said first air passage, and disposed between said second air passage and said chambers.

18. The container assembly of claim 17, wherein the fastener assembly comprises:
a first fastener insert assembly comprising a top and a bottom, said bottom having a cylinder with a curved flange over a portion of its inner circumference;
a second fastener insert assembly, the second fastener insert assembly comprising:
a first retention ring;
a second retention ring; and
an interlocking unit having a curved flange comprising a mating surface with a surface of the curved flange of the first fastener insert assembly;
wherein the first and second retention rings are configured to permit movement of said interlocking unit between said rings.
